(19) United States
(12) Patent Application Publication
(10) Pub. No.: US 2015/0300584 A1
(43) Pub. Date: Oct. 22, 2015

(54) LED FLOOR LAMP

(71) Applicant: General Luminaire Co., Ltd., Taipei City (TW)

(72) Inventors: Yung-Hong Wang, Taipei City (TW); Jun-Feng Luo, Shanghai City (CN); Chun-Lin Luo, Shanghai (CN)

(73) Assignee: General Luminaire Co., Ltd., Taipei City (TW)

(21) Appl. No.: 14/254,885

(22) Filed: Apr. 16, 2014

(51) Int. Cl. F21S 8/02; F21V 19/00; F21V 23/00; F21V 23/02

(52) U.S. Cl. CPC F21S 8/022; F21V 23/02; F21V 19/003; F21V 23/006; F21W 2131/10

(57) ABSTRACT

Disclosed are an LED floor lamp and its circuit. The LED floor lamp includes a power module and a light emitting module, and the power module includes a power circuit board and a first coil, and the light emitting module includes a light emitting circuit board, a second coil and an LED light source. The power circuit board and the light emitting circuit board are parallel to each other, and the first coil is fixed on the power circuit board and proximate to the second coil of the light emitting module, and the second coil is fixed on the light emitting circuit and proximate to the first coil of the power module. The LED light source is installed on the light emitting circuit. Therefore, the floor lamp and its circuit can be installed, adjusted, and maintained easily, and the LED light source can be changed conveniently.

### BACKGROUND OF THE INVENTION

1. Field of the Invention

The present invention relates to the field of electronic technology, and more particularly to an LED floor lamp and its circuit.

2. Description of the Related Art

An LED floor lamp refers to an LED lamp embedded into a ground, lawn or wall bottom. The LED floor lamp is used extensively in courtyards, squares and other places to provide illumination and creating views with a soft light effect without occupying useful spaces.

With reference to FIG. 1 for a conventional LED floor lamp, the conventional LED floor lamp comprises an embedded box 10, an inner holder 11, a waterproof gasket 12, a printed circuit board 13, a translucent glass 14 and a top cover 15, wherein the embedded box 10 is embedded into a ground, lawn or wall bottom to form a cavity apart from the ground, lawn or wall, and both of the inner holder 11 and the printed circuit board 13 are installed in the embedded box 10, and the printed circuit board 13 is installed on the inner holder 11, and the inner holder 11 has a fixed sleeve 110, so that after an electric wire is passed through a through hole on the inner holder and through the fixed sleeve 110, the electric wire can be connected to the printed circuit board 13 to supply electric power to the printed circuit board 13. The printed circuit board 13 has an LED light source 130 and a control chip 131 installed thereon, and both of the LED light source 130 and the control chip 131 are electrically coupled to the printed circuit board for transmitting a power signal and a control signal. The top of the inner holder has a flange, and the waterproof gasket 12 is installed on the flange and aligned evenly with a surface of the inner holder 11, and the translucent glass 14 is installed at the top of the inner holder 11 and attached to the waterproof gasket, so that the interior of the inner holder 11 becomes a sealed structure, and the top cover 15 is installed on the translucent glass 14 through a locking element, so that the top cover 15, the translucent glass 14, the waterproof gasket 12 and the printed circuit board 13 are fixed to the inner holder 11.

From the above description of the conventional LED floor lamp, the LED light source 130, the printed circuit board 13 and the electric wire 132 are fixed to one another. If the LED light source is damaged, the following two repair methods can be used: 1. It is not necessary to carry the LED light source to the installation site of the LED floor lamp, but it is necessary to cut the electric wire 132 in order to remove the printed circuit board 13 and replace the damaged LED light source 130, and then solder the electric wire 133 back to its original position before the LED floor lamp can be used normally again. 2. It is not necessary to cut the electric wire 132, but it is necessary to bring a new LED light source to the installation site of the LED floor lamp for replacement. Since the operating environment of the LED floor lamp is usually poor and has a large humidity difference, so that the failure rate of the LED light source is high, and the frequency of the replacement and repair of the LED light source is also high. Obviously, the repair, maintenance and replacement of the LED floor lamp bring tremendous inconvenience.

### SUMMARY OF THE INVENTION

Therefore, it is a primary objective of the present invention to overcome the drawbacks of the conventional LED floor lamp by providing an LED floor lamp and a circuit of the LED floor lamp that can be maintained, repaired or replaced conveniently and quickly.

To achieve the aforementioned and other objectives, the present invention provides an LED floor lamp comprising a power module 100 and a light emitting module 200, and the power module 100 includes a power circuit board 101 and a first coil 102, and the light emitting module 200 includes a light emitting circuit board 201, a second coil 202 and an LED light source 203, and the power circuit board 101 and the light emitting circuit board 201 are installed parallel to each other, and the first coil 102 is fixed onto the power circuit board 101 and disposed at a position proximate to the second coil 202 of the light emitting module 200, and the second coil 202 is fixed onto the light emitting circuit board 201 and disposed at a position proximate to the first coil 102 of the power module 100, and the LED light source 203 is installed on the light emitting circuit board 201. The present invention further provides an LED lamp circuit comprising a power conversion module, an LED driving control circuit, a wireless power transmitter module electrically coupled to the power conversion module, and a wireless power receiver module electrically coupled to the LED driving control circuit.

The LED floor lamp of the present invention and a circuit thereof can transmit power signals via wireless transmission to facilitate the installation, testing, maintenance, repair and replacement of the LED light source. In addition, the LED floor lamp can control the LED power and brightness by a control device and adjust the power and brightness of the LED light source automatically by the detection of the operating environment or power. Obviously, the present invention provides tremendous convenience and high practicality to users.

### BRIEF DESCRIPTION OF THE DRAWINGS

FIG. 1 is an exploded view of a conventional floor lamp;

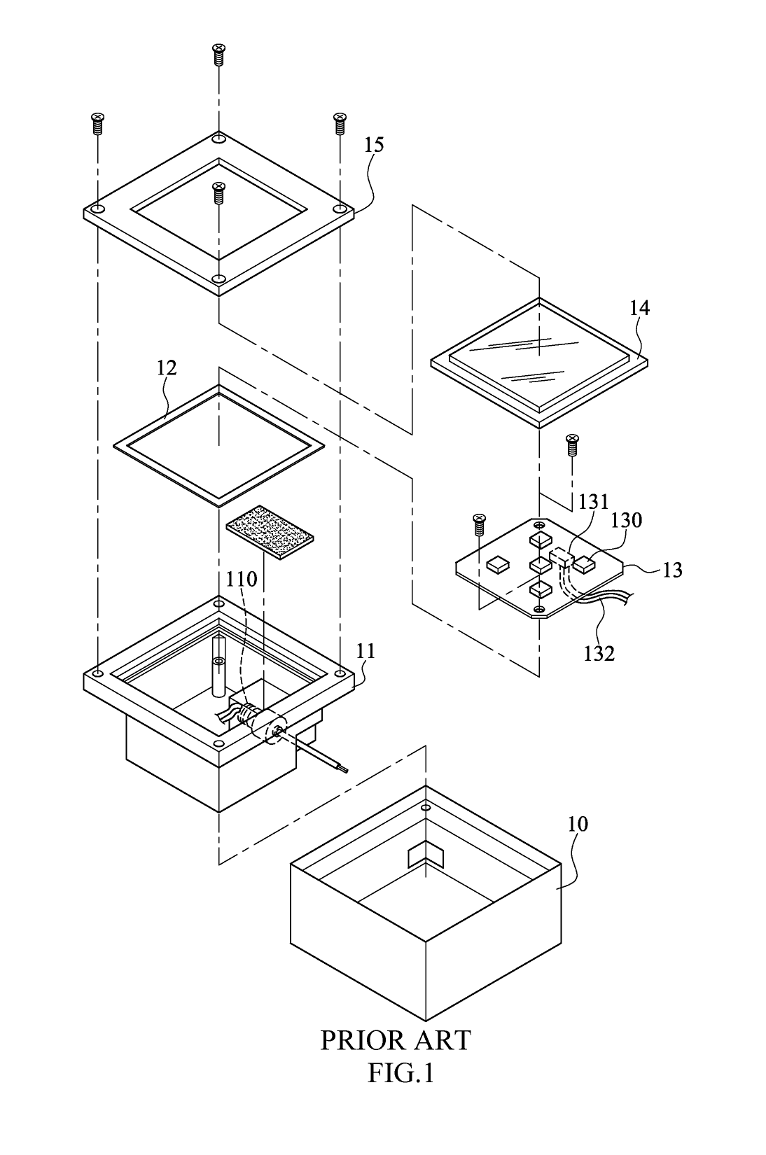

FIG. 2 is an exploded view of a floor lamp of a first preferred embodiment of the present invention;

FIG. 3 is a block diagram of a floor lamp of a second preferred embodiment of the present invention; and

FIG. 4 is a block diagram of a floor lamp of the second preferred embodiment of the present invention.

### DETAILED DESCRIPTION OF THE PREFERRED EMBODIMENTS

The technical content of the present invention will become apparent with the detailed description of preferred embodiments and the illustration of related drawings as follows. It is noteworthy that the preferred embodiments are provided for illustrating the present invention, but not intended for limiting the scope of the invention.

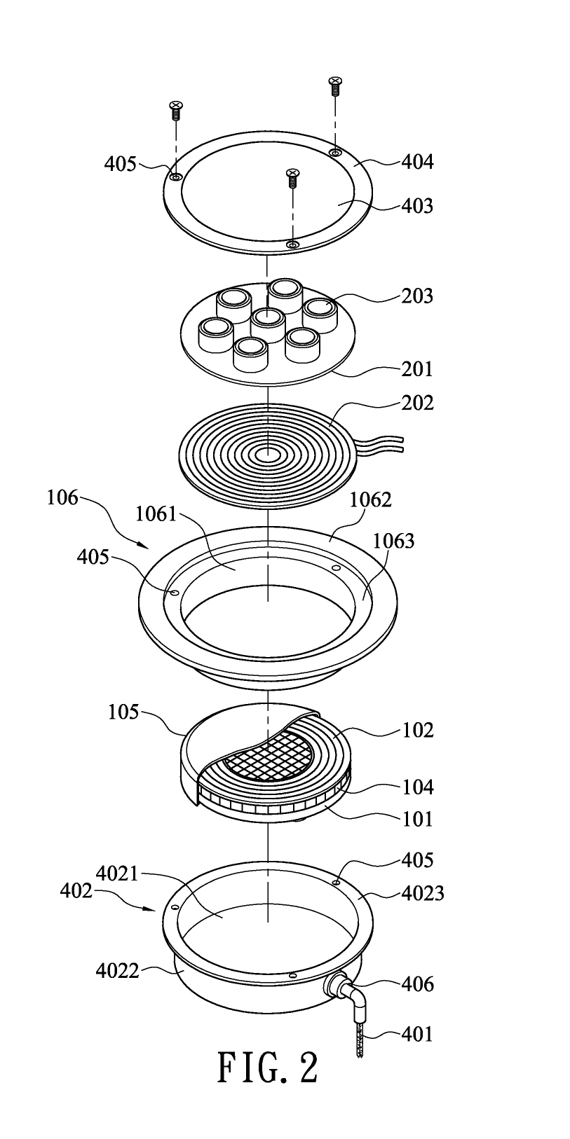

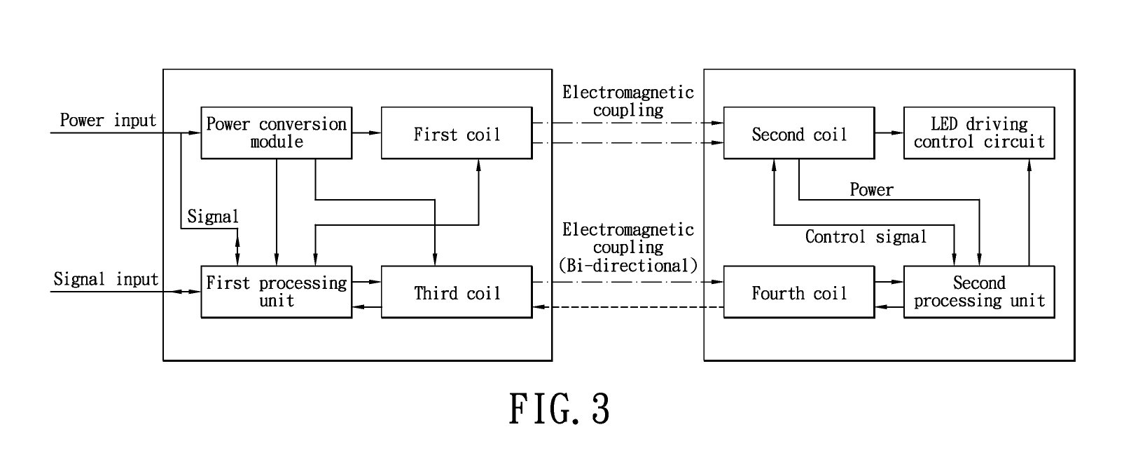

With reference to FIGS. 2 and 3 for the first preferred embodiment of the present invention, this preferred embodiment provides an LED floor lamp comprising a power module 100 and a light emitting module 200. The power module 100 includes a power circuit board 101 and a first coil 102, and the light emitting module 200 includes a light emitting circuit board 201, a second coil 202 and an LED light source 203, wherein the power circuit board 101 and the light emitting circuit board 201 are installed parallel to each other. The first coil 102 is fixed onto the power circuit board 101 and disposed at a position proximate to the second coil 202 of the light emitting module 200, and the second coil 202 is fixed onto the light emitting circuit board 201 and disposed at a position proximate to the first coil 102 of the power module 100. The LED light source 203 is installed on the light emitting circuit board 201. Persons having ordinary skill of the art could understand that the external power supply is connected to the first coil 102 via an electric wire 401 and the power circuit board 101 for supplying electric power to the first coil 102. Under the electromagnetic coupling effect, the second coil 202 generates an induced current, and the electric power is supplied to the LED light source 203 through the light emitting circuit board 201. As such, there is no physical connection (such as electric wire 401) between the power circuit board 101 and the light emitting circuit board 201. For the repair, maintenance, or replacement of the LED floor lamp, it is not necessary to cut the electric wire 401 for the removal of the light emitting circuit board 201, so that users can repair, maintain or replace the LED light source 203 conveniently.

The power module 100 includes an electromagnetic shielding substrate 104 installed between the power circuit board 101 and the first coil 102 for preventing electromagnetic interferences of the coil, so that the LED floor lamp of this preferred embodiment has a better performance.

In this preferred embodiment, the LED floor lamp further comprises a first casing 105 for covering the power module 100, and the first casing 105 has a first through hole (not shown in the figure) formed thereon, such that an end of the electric wire 401 can be passed through the first through hole into the first casing 105 and electrically coupled to the power circuit board 101, and the other end of the electric wire 401 is coupled to the power source, so as to supply electric power to the first coil 102 of the power circuit board 101.

Preferably, the light emitting circuit board 201 is in a circular shape, and the second coil 202 is a single-layer structure along the axial direction of the light emitting circuit board 201.

The quantity of LED light sources 203 is at least one.

The distance between the first coil 102 and the second coil 202 ranges from 0 cm to 20 cm.

In this preferred embodiment, the LED floor lamp further comprises a lamp panel frame 106, and the lamp panel frame 106 includes a first part 1061 and a second part 1062 fixed to the top end of the first part 1061, and both of the first part 1061 and the second part 1062 are in a cylindrical shape. And the internal diameter of the second part 1062 is equal to the external diameter of the first part 1061, so that the top end of the first part 1061 forms a first flange 1063 on an inner side of the second part 1062. Persons having ordinary skill of the art could understand that after the LED floor lamp is assembled, the power module 100 is installed in the first part 1061, and the second coil 202 is installed in the second part 1062 and supported by the top end of the first part 1061 to maintain the distance between the first coil 102 and the second coil 202. Persons having ordinary skill of the art could understand that the height of the first part 1061 is related to the distance between the first coil 102 and the second coil 202 and designed according to the distance between the first coil 102 and the second coil 202.

In this preferred embodiment, the LED floor lamp further comprises an embedding box 402 having a circular box bottom 4021 and a cylindrical box wall 4022, wherein the top of the box wall 4022 further has a second flange 4023. In this preferred embodiment, the LED floor lamp further comprises a translucent glass cover 403 and a circular top cover 404, and the circular top cover 404, the first flange 1063 and the second flange 4023 have a locking hole 405 formed separately thereon, so that the circular top cover 404, the lamp panel frame 106 and the embedding box 402 can be secured via a locking element.

The cylindrical box wall 4022 has a second through hole 406 formed thereon and disposed at a position corresponding to the first through hole, and a fixing sleeve penetrating through the first through hole and the second through hole 406 to facilitate passing the electric wire 401 into the first casing 105 to electrically connect with the power circuit board 101.

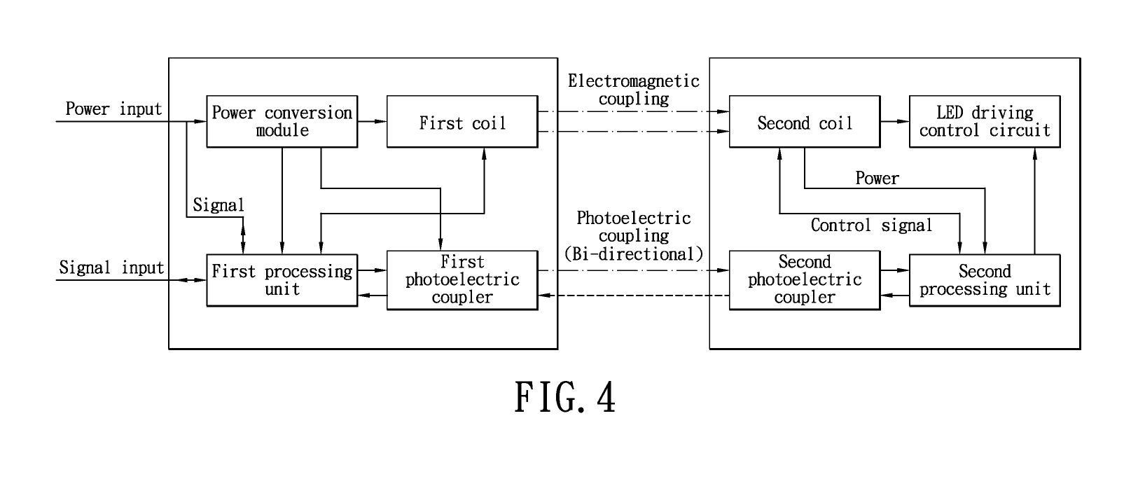

With reference to FIGS. 3 and 4 for the second preferred embodiment of the present invention, this preferred embodiment provides an LED lamp circuit comprising a power conversion module and an LED driving control circuit characterized in that the LED lamp circuit further comprises a wireless power transmitter module electrically coupled to the power conversion module and a wireless power receiver module electrically coupled to the LED driving control circuit. Persons having ordinary skill of the art could understand that the power conversion module is connected to the utility power for converting the utility power into a power signal compatible to the LED lamp circuit and transmitting the power signal to the wireless power transmitter module, and the wireless power transmitter module transmits the power signal via wireless transmission, and the wireless power receiver module receives the power signal transmitted from the wireless power transmitter module via wireless transmission and then transmits the power signal to the LED driving control circuit for controlling the light emission of the LED.

The wireless power transmitter module includes a first coil, and the wireless power receiver module includes a second coil. Persons having ordinary skill of the art could understand that the second coil is capable of generating an induced current according to an electromagnetic coupling effect to achieve the wireless transmission of the power signal.

In this preferred embodiment, the LED lamp circuit further comprises a first signal processing unit, a first control signal transmission module, a second control signal transmission module and a second processing unit sequentially and electrically coupled to one another. The first signal processing unit includes a control signal input interface, and the first signal processing unit is coupled to an output terminal of the power conversion module for receiving the power signal, and the output terminal of the second signal processing unit is coupled to the LED driving control circuit. Persons having ordinary skill of the art could understand that after the first signal processing unit has received the control signal through the control signal input interface, the control signal is transmitted to the first control signal transmission module, and the first control signal transmission module transmits the control signal to the second control signal transmission module via wireless transmission, and the second control signal transmission module transmits the control signal received to the second signal processing unit via wireless transmission, and the second signal processing unit processes the control signal and controls the LED driving control circuit according to the processed result, so as to adjust the light emission of the LED lamp.

In FIG. 3, the first control signal transmission module is a third coil, and the second control signal transmission module is a fourth coil. Persons having ordinary skill of the art could understand that the second coil generates an induced current according to the electromagnetic coupling effect to achieve the wireless transmission of the control signal.

In FIG. 4, the first control signal transmission module may be a first photoelectric coupler and the second control signal transmission module may be a second photoelectric coupler. Persons having ordinary skill of the art could understand that the first signal processing unit transmits the received control signal to the first photoelectric coupler, and the first photoelectric coupler issues a corresponding optical signal according to the control signal, and the second photoelectric coupler receives the optical signal and generates a corresponding electric control signal according to the photoelectric coupling effect and transmits the electric control signal to the second signal processing unit, and the second signal processing unit controls the LED driving control circuit according to the electric control signal to adjust the light emission of the LED lamp.

The second signal processing unit may be coupled to the wireless power receiver module, so that the second signal processing unit can control the output voltage of the wireless power receiver module according to the control signal to adjust the light emission of the LED lamp.

The second signal processing unit further comprises a power interface coupled to the wireless power receiver module, so that when the wireless power receiver module supplies power to the LED driving control circuit, electric power is also supplied to the second signal processing unit.

The second processing unit includes a detection device (not shown in the figure) coupled to the second control signal transmission module, wherein the detection device may be a temperature detection device, a humidity detection device or a power detection device, and the detection device is provided for detecting the LED lamp, and the detection result is fed back to the first signal processing unit through the second control signal transmission module and the first control signal transmission module, and the first signal processing unit adjust the output voltage of the power conversion module according to the detection result to adjust the light emission condition of the LED lamp.

The control signal input interface is the Digital Addressable Lighting Interface (DALI), Power Line Communication (PLC) interface), RS-485 interface or Pulse Width Modulation (PWM) signal interface provided for receiving electric signals of the compliant protocol.

While the invention has been described by means of specific embodiments, numerous modifications and variations could be made thereto by those skilled in the art without departing from the scope and spirit of the invention set forth in the claims.

What is claimed is:

1. An LED floor lamp, comprising:
a power module, including a power circuit board and a first coil; and
a light emitting module, including a light emitting circuit board, a second coil and an LED light source;
wherein the power circuit board and the light emitting circuit board are parallel to each other; the first coil is fixed onto the power circuit board and disposed at a position proximate to a second coil of the light emitting module; the second coil is fixed onto the light emitting circuit board and disposed at a position proximate to the first coil of the power module; and the LED light source is installed on the light emitting circuit board.

2. The LED floor lamp of claim 1, further comprising a lamp panel frame including a first part and a second part fixed to the top end of the first part, and both of the first part and the second part being in a cylindrical shape, and the internal diameter of the second part being equal to the external diameter of the first part, so that the top end of the first part forms a first flange on an internal side of the second part.

3. The LED floor lamp of claim 1, further comprising an embedding box including a circular box bottom and a cylindrical box wall, and the top of the box wall having a second flange.

4. An LED lamp circuit, comprising a power conversion module and an LED driving control circuit, and further comprising a wireless power transmitter module electrically coupled to the power conversion module and a wireless power receiver module electrically coupled to the LED driving control circuit.

5. The LED lamp circuit of claim 4, wherein the wireless power transmitter module includes a first coil, and the wireless power receiver module includes a second coil.

6. The LED lamp circuit of claim 4, further comprising a first signal processing unit, a first control signal transmission module, a second control signal transmission module and a second processing unit sequentially and electrically coupled to one another, and the first signal processing unit having a control signal input interface, wherein the first signal processing unit is coupled to an output terminal of the power conversion module, and an output terminal of the second signal processing unit is coupled to the LED driving control circuit.

7. The LED lamp circuit of claim 6, wherein the first control signal transmission module is a third coil, and the second control signal transmission module is a fourth coil.

8. The LED lamp circuit of claim 6, wherein the first control signal transmission module is a first photoelectric coupler, and the second control signal transmission module is a second photoelectric coupler.

9. The LED lamp circuit of claim 8, wherein the second processing unit includes a detection device coupled to the second control signal transmission module.
